(19) United States
(12) Patent Application Publication
(10) Pub. No.: US 2009/0015574 A1
(43) Pub. Date: Jan. 15, 2009

(54) Liquid crystal displays, timing controllers and data mapping methods

(75) Inventors: Sang-woo Kim, Suwon-si (KR); Min-soo Cho, Yongin-si (KR); Yoon-kyung Choi, Yongin-si (KR); Kyung-myun Kim, Seongnam-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/155,792

(22) Filed: Jun. 10, 2008

(30) Foreign Application Priority Data
Jul. 13, 2007 (KR) 10-2007-0070816

(51) Int. Cl. G09G 3/36; G09G 3/20

(52) U.S. Cl. 345/208; 345/94

(57) ABSTRACT

In a liquid crystal display (LCD), a liquid crystal panel includes a plurality of subpixels. Source drivers drive source lines of the liquid crystal panel and gate drivers drive gate lines of the liquid crystal panel. A timing controller generates combination pixel data using current pixel data and previous pixel data, and supplies the generated combination pixel data to the source drivers. The previous pixel data is generated by delaying the current pixel data by a first time period.

### PRIORITY STATEMENT

This nonprovisional patent application claims priority under 35 U.S.C. § 119 to Korean Patent Application No. 10-2007-0070816, filed on Jul. 13, 2007, in the Korean Intellectual Property Office, the entire contents of which are incorporated herein by reference.

### BACKGROUND

### Description of the Related Art

A conventional liquid crystal display (LCD) may be relatively compact in size and/or have relatively low power consumption. Accordingly, conventional LCDs are used in notebooks, LCD TVs, and the like. One example conventional LCD is an active matrix type LCD. An active matrix type LCD uses a thin film transistor (TFT) as a switching device. Such an active matrix type LCD is suitable for displaying videos.

A conventional LCD displays images by controlling light transmittance of a liquid crystal according to a pixel signal input to a pixel electrode in a liquid crystal panel.

FIG. 1 is a block diagram illustrating a conventional LCD. Referring to FIG. 1, a conventional LCD 100 includes a timing controller 110 for supplying timing control signals and pixel data to a gate driver 130 and a source driver 120. The source driver 120 drives source lines 150 of a liquid crystal panel 140. The gate driver 130 drives gate lines 160 of the liquid crystal panel 140. The liquid crystal panel 140 includes a plurality of pixels arrayed in matrices. The conventional LCD 100 may further include a DC/DC converter (not shown) to supply a common voltage to the liquid crystal panel 140.

In example operation, the timing controller 110 receives a data enable signal DE, a clock signal DCLK, and horizontal/vertical synchronization signals Hsync and Vsync from an external graphic source (not shown) and generates first timing control signals SSP, SSC, SOE, and POL and second timing control signals GSP, GSC, and GOE. The first timing control signals SSP, SSC, SOE, and POL control the source driver 120. The second timing control signals GSP, GSC, and GOE control the gate driver 130. The timing controller 110 also supplies pixel data R, G, and B to the source driver 130. A gamma reference voltage generator (not shown) provides a gamma reference voltage VGMA needed for the source driver 120 to convert image data into an analog image signal.

The source driver 120 converts the image data R, G, and B into analog image signals R′ G′ and B′ using the gamma reference voltage VGMA, and sequentially supplies the image signals R′ G′ and B′ corresponding to a first horizontal line to the source lines 150 in response to the first timing control signals SSP, SSC, SOE, and POL. In this example, the source lines 150 are referred to as data lines or channels. The gate driver 130 sequentially supplies scan signals (e.g., relatively high gate voltages) to the gate lines 160 in response to the second timing signals GSP, GSC, and GOE.

The liquid crystal panel 140 includes TFTs and liquid crystal cells formed at intersections of the source lines 150 and the gate lines 160. The conventional liquid crystal panel 140 may further include a storage capacitor for decreasing leakage current of the liquid crystal cells. The liquid crystal cell is connected between a common electrode and a pixel electrode, and receives a pixel signal through the TFT. An image is displayed by controlling light transmittance of a liquid crystal of the liquid crystal cell according to a voltage level of the pixel signal input to the pixel electrode.

FIG. 2 is a block diagram illustrating a conventional source driver included in a conventional LCD.

Referring to FIG. 2, the source driver 200 includes a shift register array 210 for generating sampling signals SS, a latch array 220 for latching pixel data R, G, and B, a digital-to-analog converter (DAC) array 230 for converting image data into pixel signals R′ G′ and B′, a multiplexer (MUX) array 240 for selecting the input pixel signals, and a buffer array 250 for buffering the input pixel signals. The DAC array 230 includes a positive-DAC (PDAC) array 232 and a negative-DAC (NDAC) array 234. In this example, each of the source lines SL1 to SL6 is electrically connected to a plurality of corresponding devices.

The shift register array 210 generates the sampling signals SS by shifting source start pulses SSP according to source sampling clocks SSC. The latch array 220 samples and holds the pixel data R, G, and B for a given period in response to the sampling signals SS. The DAC array 230 converts digital pixel data into analog pixel signals using positive/negative polarity gamma voltages GH and GL. The MUX array 240 selects an output of the PDAC 232 or the NDAC 234 in response to the polarity control signal POL. The buffer array 230 buffers and outputs the input pixel signal to a corresponding source line.

In order for the source driver to drive each source line, at least two DACs and a buffer may be required. However, as an area of the source driver increases, the construction of the source driver may become increasingly complex and/or more costly to manufacture.

Conventionally, a source driver having a 1:N demultiplexing structure for driving a plurality of source lines using two DACs and two buffers may be used to decrease complexity and/or manufacturing costs.

FIG. 3 is a view illustrating a conventional liquid crystal panel. Referring to FIG. 3, the conventional liquid crystal panel 300 includes a plurality of subpixels arrayed in matrices. Each of the subpixels may include a TFT and a liquid crystal cell. Each source line receives a pixel signal from a corresponding source driver and supplies the pixel signal to one or more sub pixels. The source drivers are arranged adjacent to one another and drive a plurality of adjacent source lines. The darkened subpixels among the subpixels illustrated in FIG. 3 represent subpixels driven by odd source drivers.

Conventionally, an LCD drives a liquid crystal panel using an inversion driving method to suppress and/or prevent liquid crystal deterioration and/or improve image quality. Conventional inversion driving methods include, for example, a frame inversion method of inverting a polarity of a liquid crystal cell every frame, a line inversion method of inverting a polarity of a liquid crystal cell every horizontal line and every frame, a column inversion method of inverting a polarity of a liquid crystal cell every vertical line and every frame, and a dot inversion method of inverting a polarity of a liquid crystal cell every horizontal/vertical line and every frame.

The following discussion is set forth with regard to a conventional liquid crystal panel driven using a conventional dot inversion method. Returning to FIG. 2, during a first horizontal period, the DAC array 230 converts pixel data input to the latch array 220 into a pixel signal having polarities of (+)(−)(+)(−)(+)(−), and outputs the converted pixel data. During a second horizontal period, the DAC array 230 converts pixel data input to the latch array 220 into a pixel signal having polarities of (−)(+)(−)(+)(−)(+), and outputs the converted pixel data. The polarities are also inverted every frame. Accordingly, pixel signals temporarily and spatially adjacent to each other have different polarities from each other.

In the dot inversion method, flickers that occur between adjacent liquid crystal cells in horizontal/vertical line directions may be suppressed and/or cancelled to suppress and/or prevent degradation of image quality. However, because polarities of the pixel signal are converted every horizontal/vertical line and every frame, the dot inversion method consumes greater power as compared to other inversion methods.

FIG. 4 is a view illustrating a conventional liquid crystal panel for an alternate inversion method. Referring to FIG. 4, the liquid crystal panel 400 includes a plurality of subpixels arrayed in zigzags. Each of the plurality of subpixels includes a TFT and a liquid crystal cell. The subpixels are arrayed in alternate positions with respect to the source lines. In addition, the source drivers are arrayed to be adjacent to each other, and each source driver drives a plurality of source lines disposed at given intervals. The darkened subpixels among the subpixels illustrated in FIG. 4 represent subpixels connected to odd source lines.

For example, odd gate lines are connected to a plurality of subpixels disposed on the right side with respect to the source lines, and even gate lines are connected to a plurality of subpixels disposed on the left side with respect to the source lines. A first source driver SD1 supplies six pixel signals to channels when driving odd horizontal lines, but supplies a dummy signal and five shifted pixel signals to channels when driving even horizontal lines. The shifted pixel signals are signals shifted to the right by a channel.

A second source driver SD2 supplies six pixel signals to channels when driving odd horizontal lines and supplies six shifted pixel signals to channels when driving even horizontal lines. In this example, R, G, and B pixel data is input from a timing controller (not shown) to the second source driver SD2 in unit of, for example, 24-bit groups through three buses.

When the second source driver SD2 drives even horizontal lines, the second source driver SD2 must perform proper data mapping using pixel data belonging to at least three groups. However, when the data mapping is performed in the source driver, the construction of the source driver may be more complex and/or an area of the source driver may increase because, in order to perform the data mapping, data is generated to have different combinations according to a type of the liquid crystal panel, a type of the horizontal line, and a source scan direction. Complexity and/or an area of the source driver further increases when the liquid crystal panel for alternate inversion and the source driver having the 1:N demultiplexing structure are combined to construct the LCD.

### SUMMARY

Example embodiments provide liquid crystal displays (LCDs) and data mapping methods capable of more effectively driving (e.g., performing time-division driving on) source lines included in a liquid crystal panel without increasing source driver area.

Example embodiments relate to liquid crystal displays (LCDs), for example, LCDs and data mapping methods capable of more effectively and/or more simply performing an inversion driving method used to suppress and/or prevent image quality deterioration of an LCD driver integrated chip (IC) for a display panel (e.g., low temperature polysilicon (LTPS) panel).

At least one example embodiment provides a liquid crystal display (LCD). According to at least this example embodiment, a liquid crystal panel may include a plurality of subpixels, and a plurality of source drivers. Each of the plurality of source drivers may be configured to drive a plurality of source lines of the liquid crystal panel. Each of a plurality of gate drivers may be configured to drive a plurality of gate lines of the liquid crystal panel. A timing controller may be configured to generate combination pixel data based on current pixel data and previous pixel data and supply the generated combination pixel data to the source drivers. The previous pixel data may be generated by delaying the current pixel data by a first time period.

According to at least some example embodiments, the timing controller may generate the combination pixel data based on a source scan direction and a gate line number. The timing controller may generate the combination pixel data based only on the current pixel data when the source scan direction is a first of a plurality of source scan directions and the gate line number is a first of a plurality of line numbers. The timing controller may generate the combination pixel data based on the current pixel data and the previous pixel data when the source scan direction is a first of a plurality of directions and the gate line number is a second of a plurality of line numbers.

According to at least some example embodiments, the timing controller may generate the combination pixel data based only on the previous pixel data when the source scan direction is a second of a plurality of directions and the gate line number is a first of a plurality of line numbers. The timing controller may generate the combination pixel data based on the current pixel data and the previous pixel data when the source scan direction is a second of a plurality of directions and the gate line number is a second of a plurality of line numbers. The timing controller may generate the combination pixel data based on a structure of the liquid crystal panel.

According to at least some example embodiments, the timing controller may generate the combination pixel data based on a structure of the plurality of source drivers.

According to at least some example embodiments, the excluded portion of the current pixel data may include a last 8 bits of the current pixel data and the portion of the previous pixel data may include the last 8 bits of the previous pixel data. The portion of the current pixel data may correspond to an excluded portion of the previous pixel data. The current pixel data may include 8-bit pixel data that is third to last in a sequence of 8-bit current pixel data, and the excluded portion of the previous pixel data may include 8-bit pixel data that is third to last in a sequence of 8-bit previous pixel data. The timing controller may generate (N×M)-bit current pixel data, where M is a natural number, by buffering N-bit input pixel data, where N is a natural number, input from an external graphic source. The number M may be determined according to the number of source lines connected to each of the source drivers and the number of bits of pixel data. The number of the source lines may be 12, the number of the pixel data may be 8 bit pixel data, N may be 24, and M may be 4.

According to at least some example embodiments, the plurality of subpixels may be connected to a plurality of first source lines that are adjacent to each other in a first direction along a first horizontal line, and may be connected to a plurality of second source lines that are adjacent to each other in a second direction along a second horizontal line.

According to at least some example embodiments, the liquid crystal panel may include, a plurality of odd source lines connected in common, and a plurality of even source lines connected in common. Each source driver may include a first output line connected to the plurality of odd source lines, and a second output line connected to the plurality of even source lines.

At least one other example embodiment provides a timing controller. According to at least this example embodiment, a buffer may be configured to generate (N×M)-bit current pixel data based on N-bit input pixel data, and a delay device may be configured to generate (N×M)-bit previous pixel data by delaying the current pixel data by a first time period. A control signal generator may be configured to generate a source scan direction signal and a gate line number signal, and a data mapping unit may be configured to generate combination pixel data based on the current pixel data, the previous pixel data, the source scan direction signal, and the gate line number signal.

According to at least some example embodiments, the data mapping unit may generate the combination pixel data according to the source scan direction signal and the gate line number signal using the current pixel data and the previous pixel data. The delay device may delay the current pixel data by a time corresponding to a time to supply the combination pixel data to each of a plurality of source drivers.

The control signal generator may be configured to generate a first source scan direction signal representing that a source scan direction is a first direction with respect to the center of a liquid crystal panel. The control signal generator may be further configured to generate a second source scan direction signal representing that the source scan direction is a second direction with respect to the center of the liquid crystal panel. The first direction may be different from the second direction.

According to at least some example embodiments, the control signal generator may be further configured to generate a first line number signal representing that a gate line number is an odd line, and generate a second line number signal representing that the gate line number is an even line. The data mapping unit may generate dummy data according to the source scan signal and the gate line number and supplies the dummy data to the source driver.

At least one other example embodiment provides a method for generating combination pixel data and driving a liquid crystal panel. According to at least this example embodiment, combination pixel data may be generated based on current pixel data and previous pixel data. The previous pixel data may be generated by delaying the current pixel data by a first time period. A liquid crystal panel may be driven by supplying the generated combination pixel data to the source driver.

According to at least some example embodiments, the combination pixel data may be generated according to a source scan direction and a gate line number. The current pixel data may be (24×M)-bit current pixel data, and the may be generated by buffering 24-bit input pixel data.

### BRIEF DESCRIPTION OF THE DRAWINGS

Example embodiments will become more apparent by describing in detail the example embodiments shown in the attached drawings in which:

FIG. 1 is a block diagram illustrating a conventional liquid crystal display (LCD);

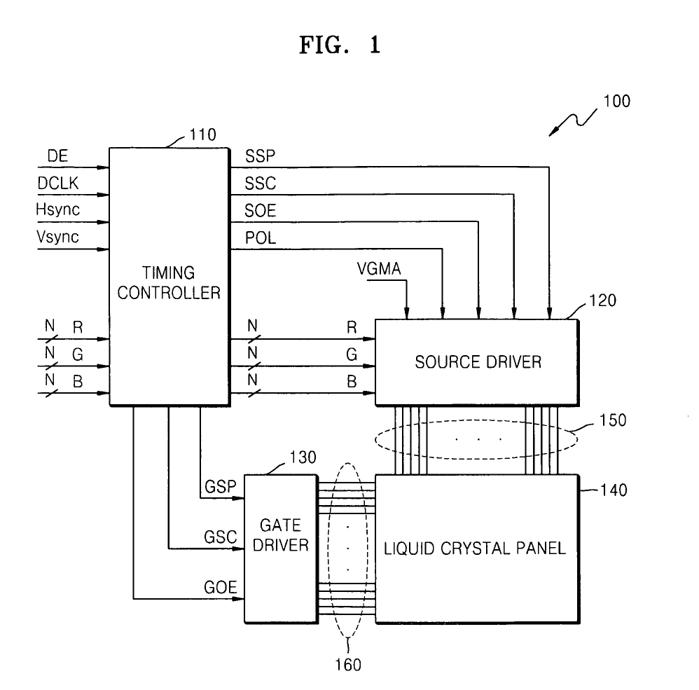

FIG. 2 is a block diagram illustrating a conventional source driver;

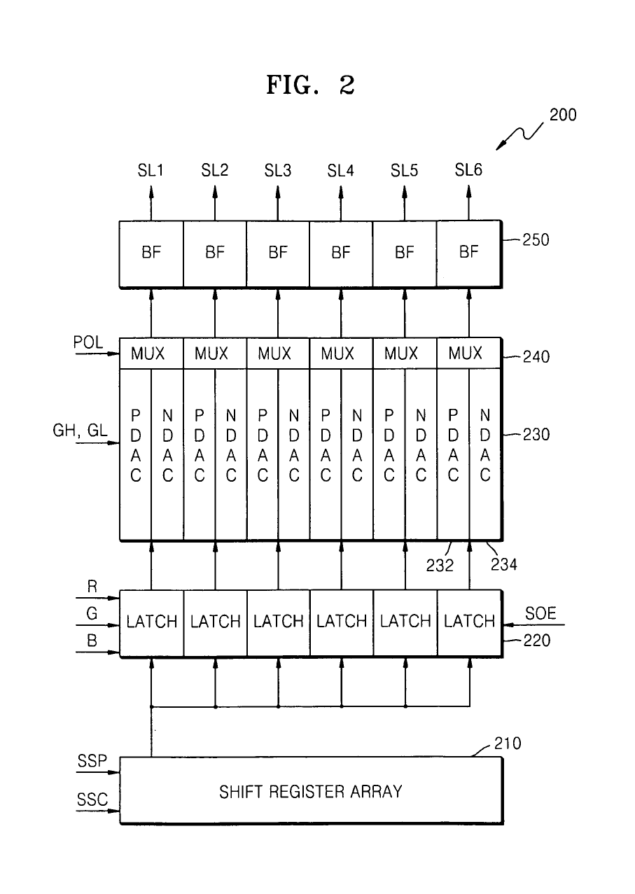

FIG. 3 is a view illustrating a conventional liquid crystal panel;

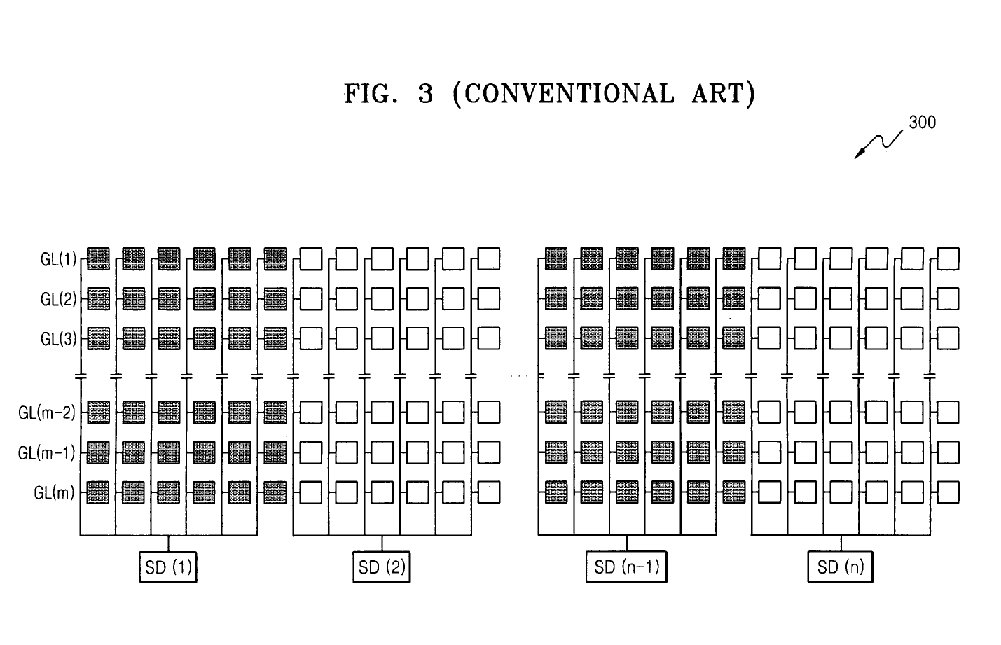

FIG. 4 is a view illustrating a conventional liquid crystal panel for alternate inversion;

FIG. 5 is a block diagram illustrating a timing controller according to an example embodiment;

FIG. 6 is a block diagram illustrating a source driver according to an example embodiment;

FIG. 7 is a block diagram illustrating a liquid crystal panel according to an example embodiment;

FIG. 8 is a block diagram for explaining a data mapping method according to the example embodiment;

FIG. 9 is a block diagram for explaining a data mapping method according to another example embodiment;

FIG. 10 is a block diagram for explaining a data mapping method according to another example embodiment; and

FIG. 11 is a block diagram for explaining a data mapping method according to another example embodiment.

### DETAILED DESCRIPTION OF EXAMPLE EMBODIMENTS

Various example embodiments of the present invention will now be described more fully with reference to the accompanying drawings in which some example embodiments of the invention are shown. In the drawings, the thicknesses of layers and regions are exaggerated for clarity.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Hereinafter, example embodiments will be described in detail with reference to the attached drawings. In the description, the detailed descriptions of well-known functions and structures have been omitted so as not to hinder the understanding of the present invention.

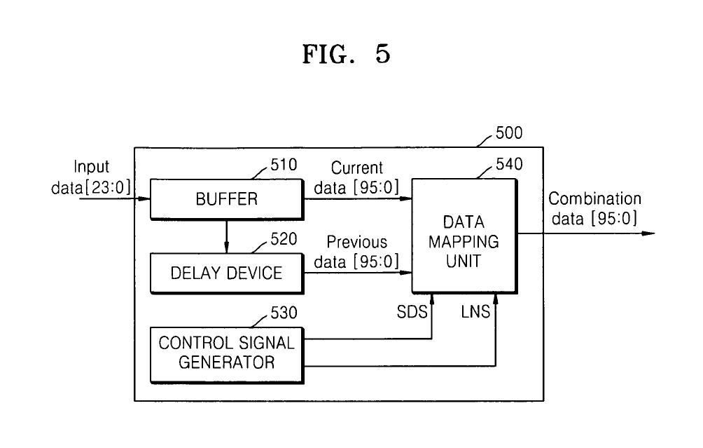

FIG. 5 is a block diagram illustrating a timing controller according to an example embodiment.

Referring to FIG. 5, a timing controller 500 may include a buffer 510, a delay device 520, a control signal generator 530, and a data mapping circuit or unit 540. The buffer 510 may receive multi-bit (or N-bit) pixel data M times (where N and M are natural numbers) from an external graphic source (not shown). The buffer 510 may generate (N×M)-bit pixel data based on the received pixel data. In one example, each of R, G, and B pixel data may be 8-bit data, which may be simultaneously or concurrently input through a plurality of buses (e.g., 3 buses). In one example, N may be 24. If pixel data input to the timing controller 500 has 24 bits, the buffer 510 may buffer the pixel data in units of 24 bits, and may output the pixel data in units of 24×M bits.

The number M may be determined according to the number of source lines, a structure of a source driver, and/or the number of bits of the R, G, and B data. But, because the source driver according to this example embodiment drives 12 source lines, M may be 4. In this example, the buffer 510 may reduce a frequency of a clock signal, for example, by about ¼ to suppress and/or prevent timing problems in the source driver caused by, for example, relatively high-speed operations.

For example, when a size of pixel data transmitted to a source driver of a WXVGA is 24 bits, an internal operating speed may be about 85 MHz. But, when the size of pixel data is 96 bits, the internal operating speed may be about 21 MHz.

The delay device 520 may receive the (N×M)-bit pixel data from the buffer 510, delay the (N×M)-bit pixel data by a first time period and output the delayed (N×M)-bit pixel data. In this example, because 96-bit pixel data is simultaneously or concurrently input to the source drivers, and the timing controller 500 supplies pixel data to the source drivers at given time intervals, the given or first time period may be the same or substantially the same as the time interval. Accordingly, the buffer 510 may output current pixel data, and the delay device 510 may output previous pixel data. The current pixel data output from the buffer 510 and the previous pixel data output from the delay device 510 may be input to the data mapping unit 540.

The control signal generator 530 may generate a scan direction signal SD and a line number signal LM. The scan direction signal SD represents a scan direction of a source line. The line number signal LM represents a type of a gate line. According to example embodiments, scanning may be performed in a first direction (e.g., from left to right) with respect to the center of a liquid crystal panel. However, according to user's setting, scanning may be performed in a second direction (e.g., from right to left). In addition, input instructions of the pixel data may be changed or determined according to whether the gate line is an odd gate line or even gate line. The control signal generator 530 may generate a timing control signal for controlling a gate driver and a source driver.

The data mapping unit 540 may receive the current pixel data, the previous pixel data, and/or the scan direction signal SD and the line number signal LM from the buffer 510, the delay device 520, and the control signal generator 530, respectively. The data mapping unit 540 may combine the current pixel data and the previous pixel data according to the scan direction signal SD and/or the line number signal LM to generate combination pixel data. The combination pixel data generated by the data mapping unit 540 may be input to each source driver (not shown). The combination pixel data will be described later in more detail below.

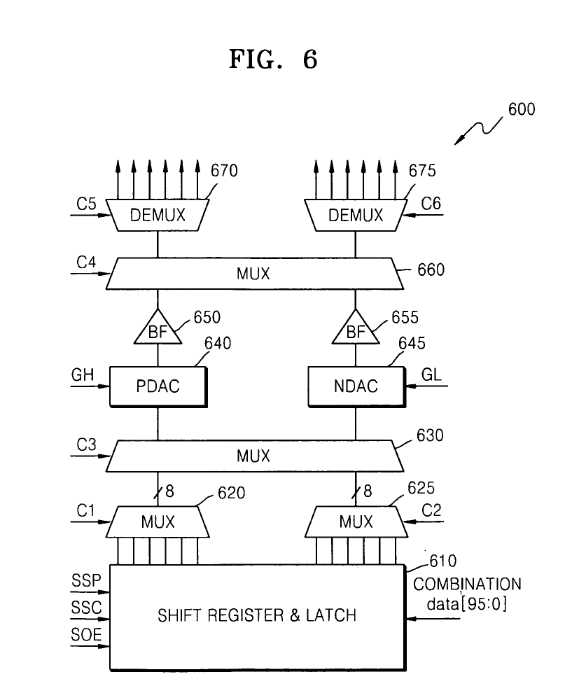

FIG. 6 is a block diagram illustrating a source driver according to an example embodiment.

Referring to FIG. 6, the source driver 600 may include a shift register and latch 610, first multiplexers 620 and 625, a second multiplexer 630, digital-to-analog converters (DACs) 640 and 645, buffers 650 and 655, a third multiplexer 660, and demultiplexers 670 and 675. Each of the demultiplexers 670 and 675 of the source driver 600 may supply pixel data to each of a plurality of (e.g., six) source lines such that the source driver 600 drives a plurality of (e.g., twelve) source lines.

The shift register and latch 610 may receive a source start pulse SSP, a source shift clock signal SSC, a source output enable signal SOE, and combination pixel data. The shift register and latch 610 may shift (e.g., sequentially shift) the source start pulse SSP according to the source shift clock signal SSC to generate a sampling signal SS. The shift register and latch 610 may sample and latch the combination pixel data in given units according to the sampling signal SS and simultaneously or concurrently output the latched combination pixel data to the first multiplexers 620 and 625 in response to the source output enable signal SOE.

The first multiplexers 620 and 625 may selectively output pixel data input from the shift register and latch 610 in response to control signals C1 and C2. For example, each of the first multiplexer 620 and 625 may receive a multi-bit (e.g., 48-bit) pixel data through a plurality of (e.g., six) channels and may output multi-bit (e.g., 8-bit) pixel data through a channel. The second multiplexer 630 may output the pixel data input from the first multiplexers 620 and 625 to the first DAC 640 or the second DAC 645 in response to a control signal C3.

The first DAC 640 may convert the pixel data into a positive polarity pixel signal by using a positive polarity gamma voltage GH. The second DAC 645 may convert the pixel data into a negative polarity pixel signal using a negative polarity gamma voltage GL. The buffers 650 and 655 may buffer and output the input pixel signals to the third multiplexer 660. The third multiplexer 660 may output the pixel signals input from the buffers 650 and 655 to the first or second demultiplexer 670 or 675 in response to a control signal C4.

The demultiplexers 670 and 675 may supply the pixel signal input from the third multiplexer 660 to a plurality of (e.g., six) source lines in response to control signals C5 and C6, respectively. The source lines connected to each of the demultiplexers 670 and 675 may be arranged at given intervals, but not adjacent to one another. For example, output lines of the first and second demultiplexers 670 and 675 may be interleaved. In a more specific example, a first output line of the first demultiplexer 670 may be adjacent to a first output line of the second demultiplexer 675, and so on. A construction of a liquid crystal panel connected to the demultiplexers 670 and 675 and the combination pixel data input to the source driver 600 will be described in more detail below.

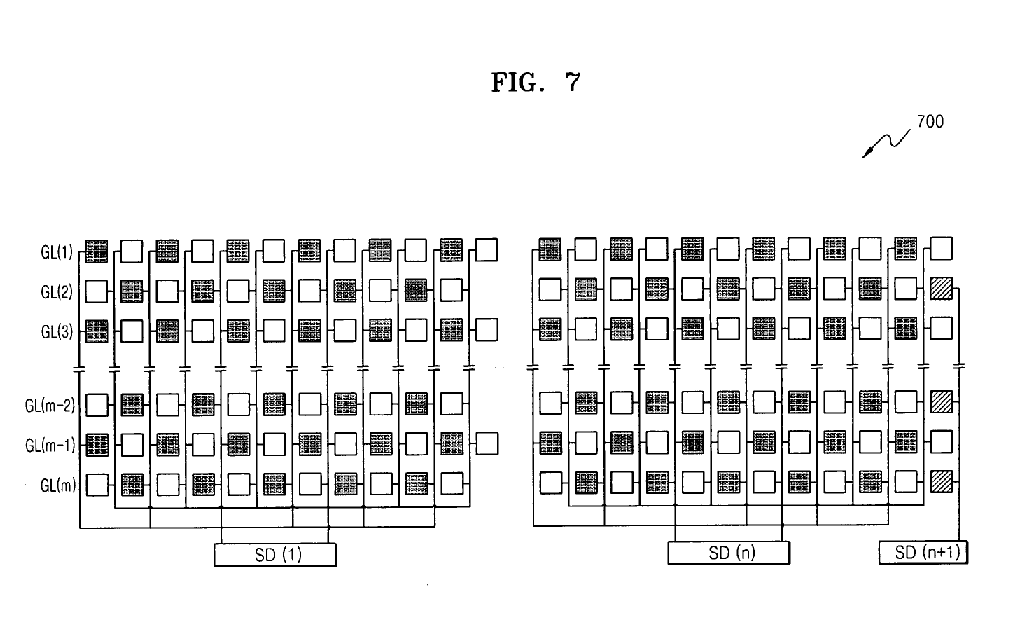

FIG. 7 is a block diagram illustrating a liquid crystal panel according to an example embodiment.

Referring to FIG. 7, the liquid crystal panel 700 according to this example embodiment may include (n+1) source drivers, where n is a natural number. Excluding the (n+1)-th source driver SD(n+1), each of remaining n source drivers SD(1) to SD(n) may drive a plurality of (e.g., twelve) source lines. The liquid crystal panel 700 may include subpixels, which may be formed at intersections of gate lines and source lines (e.g., at regions where the gate lines and the source lines intersect). Each of the subpixels may include a TFT (not shown) and a liquid crystal cell (not shown).

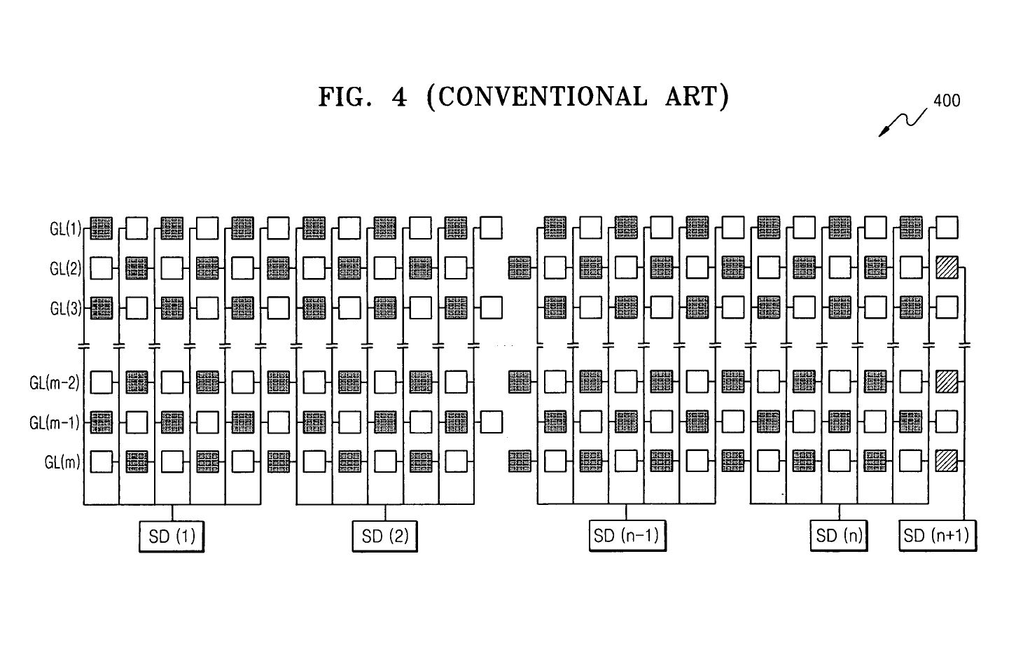

The liquid crystal panel 700 according to at least this example embodiment may have a liquid crystal panel structure for alternate inversion. Therefore, the subpixels may be arrayed in alternate positions with respect to the source lines. However, a connection structure of the source lines of the liquid crystal panel 700 and the number of the source drivers connected to the liquid crystal panel 700 may be different from those of the liquid crystal panel 400 illustrated in FIG. 4. The darkened subpixels among the subpixels illustrated in FIG. 7 represent subpixels connected to odd source lines.

The liquid crystal panel driven by the first to n-th source drivers SD(1) to SD(n) will now be described. Each of the first to n-th source drivers SD(1) to SD(n) may be connected to a plurality of (e.g., twelve) source lines. For example, subpixels connected to odd gate lines may be connected to first to twelfth source lines on the left, and subpixels connected to even gate lines may be connected to second to twelfth source lines on the right.

The liquid crystal panel driven by the (n+1)-th source driver SD(n+1) will now be described. The (n+1)-th source driver SD(n+1) may be connected to the rightmost source line from among the source lines of the liquid crystal panel 700. More particularly, for example, the (n+1)-th source driver SD(n+1) may be connected to subpixels connected to even gate lines. Therefore, because each of remaining source drivers, except the last source driver, drives a plurality of (e.g., twelve) source lines, the liquid crystal panel 700 according to this example embodiment may include (12n+1) source lines.

The liquid crystal panel 700 according to this example embodiment may have a source line connection structure different from that of the liquid crystal panel 400. For example, the odd source lines may be connected to each other, and the even source lines may be connected to each other. Therefore, by applying positive/negative polarity pixel signals to the odd source lines, applying negative/positive polarity pixel signals to the even source lines, and changing the polarities every horizontal line and every frame, a column inversion method, a dot inversion method, and an alternate inversion method may be implemented more easily.

The liquid crystal panel 700 according to this example embodiment may require a different number of source drivers than the number of source drivers needed for the liquid crystal panel 400 illustrated in FIG. 4. For example, the liquid crystal panel 700 according to this example embodiment may be connected to the integrated type source drivers SD(1) to SD(n) integrating the source drivers for driving the odd source lines with the source lines for driving the even source lines and to the (n+1)-th source driver SD(n+1). Therefore, the number of source drivers needed may be decreased by about half.

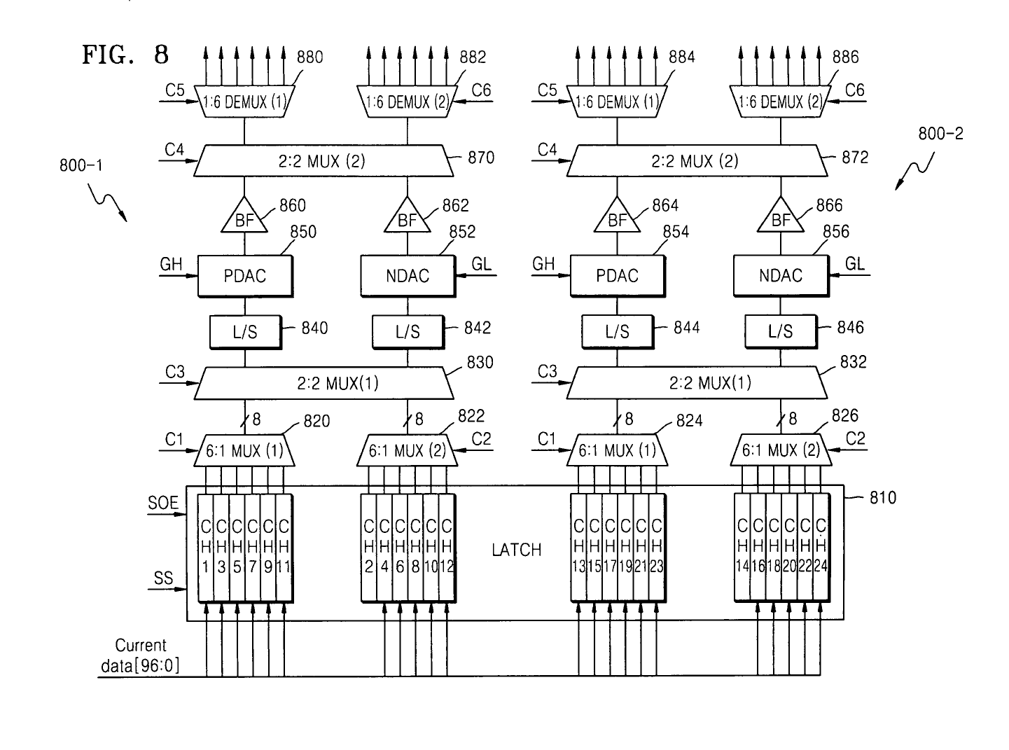

FIG. 8 is a block diagram for explaining a data mapping method according to an example embodiment. In more detail, FIG. 8 illustrates an example in which combination pixel data is input to a latch 810 when source scanning is performed in a first direction (e.g., from left to right) with respect to the center of a liquid crystal panel and a source driver drives odd horizontal lines. Hereinafter, the aforementioned condition is referred to as a first condition.

Referring to FIG. 8, source drivers 800-1 and 800-2 according to this example embodiment may include the latch 810, first multiplexers 820 to 826, second multiplexers 830 and 832, level shifters 840 to 846, DACs 850 to 856, buffers 860 to 866, third multiplexers 870 and 872, and demultiplexers 880 to 886. Each of the source drivers 800-1 and 800-2 illustrated in FIG. 8 may drive a plurality of (e.g., twelve) source lines. Although not shown in the figure, it will be understood that the number of the source drivers is not 2, but (n+1).

Operations of the first multiplexers 820 to 826, the second multiplexers 830 and 832, the DACs 850 to 856, the buffers 860 to 866, and the third multiplexers 870 and 872 are the same or the substantially the same as described above. Accordingly, a detailed description thereof is omitted. The latch 810 and the demultiplexers 880 to 886 will be described in detail below. The level shifters 840 to 846 may boost and output the voltage of pixel data output from the second multiplexers 830 and 832.

The 1:6 demultiplexer 880 may be connected to a plurality of (e.g., six) source lines included in the liquid crystal panel 700 illustrated in FIG. 7. For example, the output lines of the 1:6 demultiplexer 880 may be connected to odd source lines (e.g., 1^{st}, 3^{rd}, 5^{th}, 7^{th}, 9^{th}, and 11^{th} source lines). Similarly, the 1:6 demultiplexer 882 may be connected to a plurality of (e.g., six) source lines included in the liquid crystal panel 700 illustrated in FIG. 7. For example, the output lines of the 1:6 demultiplexer 882 may be connected to even source lines (e.g., 2^{nd}, 4^{th}, 6^{th}, 8^{th}, 10^{th}, and 12^{th} source lines).

Returning to FIG. 5, a timing controller 500 according to this example embodiment may include the data mapping unit 540 for generating the combination pixel data using the current pixel data and the previous pixel data. The timing controller 500 may further include the control signal generator 530 to generate the scan direction signal SDS and the line number signal LNS. Therefore, the timing controller 500 according to this example embodiment may generate and supply the combination pixel data corresponding to a source scan direction and a gate line number to the source drivers 800-1 and 800-2.

The data mapping unit 540 may receive the current pixel data, the previous pixel data, a first scan direction signal, and a first line number signal, and may generate the combination pixel data using the current pixel data. In one example, the combination pixel data may be generated without using the previous pixel data, but using only the current pixel data. The first scan direction signal may be a signal representing that the source scanning is performed in the first direction (e.g., from left to right), and the first line number signal may represent that the gate lines that are driven are the odd gate lines.

As described above, the buffer 510 may receive multi-bit (e.g., 24-bit) input pixel data and generate multi-bit (e.g., 96-bit) current pixel data. Therefore, in the first condition (e.g., when scanning in the first direction), the data mapping unit 540 may generate the combination pixel data using only the current pixel data. For example, after the data mapping unit 540 divides the multi-bit (e.g., 96-bit) current pixel data output from the buffer 510 into multi-bit (e.g., 8-bit) data groups, the data mapping unit 540 may rearrange the order of the divided data groups to generate the combination pixel data to be input to the latch 810 illustrated in FIG. 8. Because the buffer 510 has a plurality of (e.g., twelve) output lines, the combination pixel data may be generated by changing the order of the output lines.

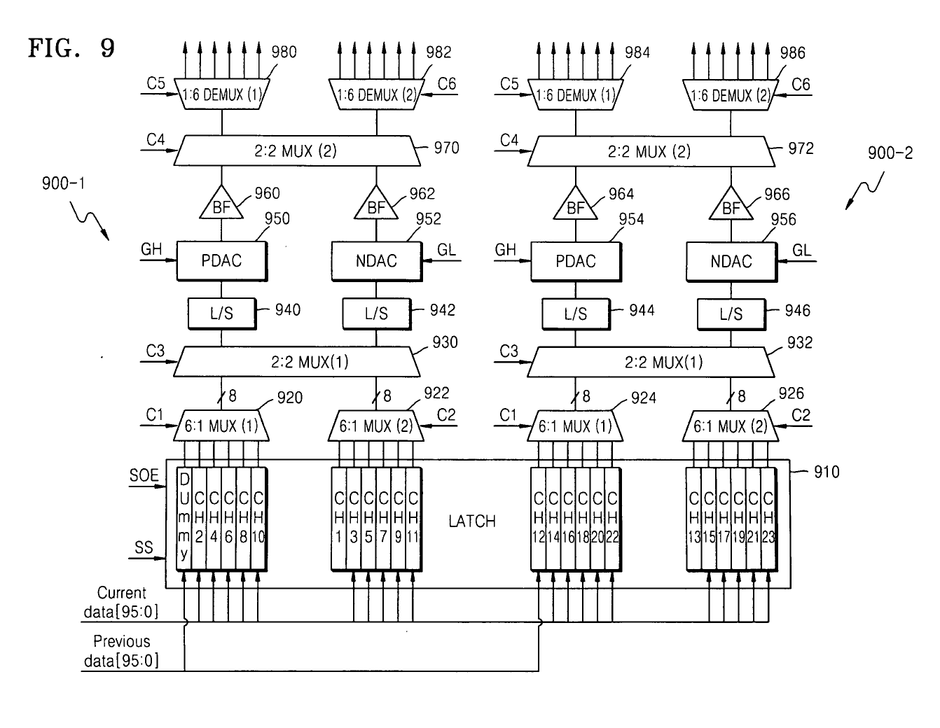

FIG. 9 is a block diagram for explaining a data mapping method according to another example embodiment. In more detail, FIG. 9 is a view illustrating combination pixel data that may be input to a latch 910 when source scanning is performed in a first direction (e.g., from left to right) with respect to the center of a liquid crystal panel and a source driver drives even horizontal lines. Hereinafter, the aforementioned condition is referred to as a second condition.

Referring to FIG. 9, source drivers 900-1 and 900-2 according to this example embodiment may include a latch 910, first multiplexers 920 to 926, second multiplexers 930 and 932, level shifters 940 to 946, DACs 950 to 956, buffers 960 to 966, third multiplexers 970 and 972, and demultiplexers 980 to 986. The latch 910 and the demultiplexers 980 to 986 will be described in more detail below. Although not shown in the figure, it will be understood that the number of the source drivers is not 2, but (n+1).

The 1:6 demultiplexer 980 may be connected to a plurality of (e.g., six) source lines included in the liquid crystal panel 700 illustrated in FIG. 7. The output lines of the 1:6 demultiplexer 980 may be connected to odd source lines (e.g., 1^{st}, 3^{rd}, 5^{th}, 7^{th}, 9^{th}, and 11^{th} source lines). Similarly, the 1:6 demultiplexer 982 may be connected to a plurality of (e.g., six) source lines included in the liquid crystal panel 700 illustrated in FIG. 7. In more detail, the output lines of the 1:6 demultiplexer 982 may be connected to even source lines (e.g., 2^{nd}, 4^{th}, 6^{th}, 8^{th}, 10^{th}, and 12^{th} source lines).

The number of the odd source lines connected to the 1:6 demultiplexer 980 may be 6, but along even gate lines, only five source lines may be connected to subpixels. Therefore, while an even horizontal line is driven, dummy data may be input to a first source line (or first channel). In addition, a first pixel signal (e.g., R1) may be input to a second source line (or second channel) connected to the 1:6 demultiplexer 982. The timing controller 500 according to this example embodiment may generate the combination data according to the connection structure of the source lines described above.

Returning to FIG. 5, the timing controller 500 according to this example embodiment may include the data mapping unit 540 for generating the combination pixel data using the current pixel data and the previous pixel data. The control signal generator 630 may generate the scan direction signal SDS and the line number signal LNS. Therefore, the timing controller 500 according to this example embodiment may generate and supply the combination pixel data to the source drivers 900-1 and 900-2 according to a source scan direction and a gate line number.

The data mapping unit 540 may receive the current pixel data, the previous pixel data, a first scan direction signal, and a second line number signal, and may generate the combination pixel data using the current pixel data and the previous pixel data. In more detail, the combination pixel data may be generated using a portion of the current pixel data and a portion of the previous pixel data. In this example, a portion of the current pixel data may be excluded and replaced by a portion of the previous pixel data. The excluded portion of the current pixel data may correspond to the portion of the previous pixel data used in generating the combination pixel data. For example, the combination pixel data may be generated using a plurality of (e.g., 88) bits of the current pixel data, excluding a last certain number of (e.g., 8) bits, and a last certain number (e.g., 8) bits of the previous pixel data. The number of bits excluded from the current pixel data may correspond (e.g., in position) to the included portion of the previous pixel data. The data mapping unit 540 may also generate dummy data to be supplied to the first source line (first channel). The first scan direction signal may represent that source scanning is performed in a first direction (e.g., from left to right), and the second line number signal may represent that gate lines that are driven are even gate lines.

As described above, the buffer 510 receives multi-bit (e.g., 24-bit) input pixel data and generates multi-bit (e.g., 96-bit) current pixel data. Therefore, in the second condition, the combination pixel data may be generated by using a portion of the current pixel data and a portion of the previous pixel data. Combination pixel data to be supplied to the first source driver 900-1 may be generated by using upper plurality of (e.g., 88) bits of the current pixel data and the dummy data. Combination pixel data supplied to the source drivers SD(2) to SD(n) excluding the first source driver SD(1) will be described in more detail below.

The data mapping unit 540 may divide the multi-bit (e.g., 96-bit) current pixel data output from the buffer 510 into multi-bit (e.g., 8-bit) groups, extract a plurality of (e.g., 11) upper data groups, divide the multi-bit (e.g., 96-bit) previous pixel data output from the delay device 520 into multi-bit (e.g., 8-bit) groups, extract a lower data group, and rearrange the order of the extracted data groups, to generate the combination pixel data that may be input to the latch 910 illustrated in FIG. 9. In this example, because each of the buffer 510 and the delay device 520 has a plurality of (e.g., twelve) output lines, the combination pixel data may be generated by changing the order of the output lines. Although the dummy data is illustrated as the previous pixel data in FIG. 9 for convenience, the dummy data may not represent the previous pixel data.

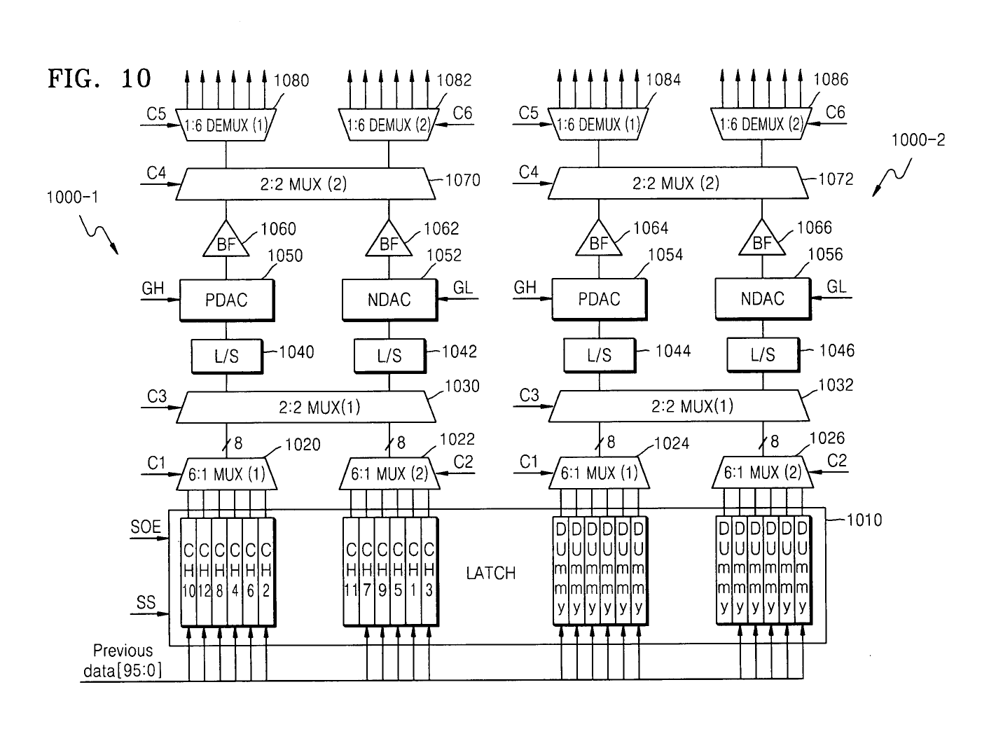

FIG. 10 is a block diagram for explaining a data mapping method according to another example embodiment. In more detail, FIG. 10 is a view illustrating combination pixel data input to a latch 1010 when source scanning is performed in a second direction (e.g., from right to left) with respect to the center of a liquid crystal panel and a source driver drives odd horizontal lines. Hereinafter, the aforementioned condition is referred to as a third condition.

Referring to FIG. 10, source drivers 1000-1 and 1000-2 according to this example embodiment may include the latch 1010, first multiplexers 1020 to 1026, second multiplexers 1030 and 1032, level shifters 1040 to 1046, DACs 1050 to 1056, buffers 1060 to 1066, third multiplexers 1070 and 1072, and demultiplexers 1080 to 1086. The latch 1010 and the demultiplexers 1080 to 1086 will be described in detail. Although not shown in the figure, it will be understood that the number of the source drivers is not 2, but (n+1).

Irrespective or independent of a source scan direction, pixel signals may be input to subpixels in order of R, G, and B. For example, irrespective of whether the source scan direction is a first or second direction, pixel data may input in the order of R, G, and B. For example, when the total number of subpixels in a single gate line is 12n, a B pixel signal, a G pixel signal, and an R pixel signal may be input to a (12n)-th subpixel, a (12n−1)-th subpixel, and a (12n−2)-th subpixel, respectively.

The 1:6 demultiplexer 1080 may be connected to a plurality of (e.g., six) source lines included in the liquid crystal panel 700 illustrated in FIG. 7. For example, the output lines of the 1:6 demultiplexer 1080 may be connected to odd source lines (e.g., (12n−1)-th, (12n−3)-th, (12n−5)-th, (12n−7)-th, (12n−9)-th, and (12n−11)-th source lines). Similarly, the 1:6 demultiplexer 1082 may be connected to a plurality of (e.g., six) source lines included in the liquid crystal panel 700 illustrated in FIG. 7. For example, the output lines of the 1:6 demultiplexer 1082 may be connected to even source lines (e.g., (12n)-th, (12n−2)-th, (12n−4)-th, (12n−6)-th, (12n−8)-th, and (12n−10)-th source lines). The 1:6 demultiplexer 1084 may be connected to a (12n+1)-th source line.

Returning to FIG. 5, the timing controller 500 according to this example embodiment may include the data mapping unit 540 to generate the combination pixel data using the current pixel data and the previous pixel data. The control signal generator 530 may generate a scan direction signal SDS and a line number signal LNS. Therefore, the timing controller 500 according to this example embodiment may generate and supply the combination pixel data corresponding to a source scan direction and a gate line number to the source drivers 1000-1 and 1000-2.

The data mapping unit 540 may receive the current pixel data, the previous pixel data, a second scan direction signal, and a first line number signal, and generate the combination pixel data by using the previous pixel data. For example, the combination pixel data may be generated using only the previous pixel data, but without using the current pixel data. The second scan direction signal may represent that the source scanning is performed in the second direction (e.g., from right to left), and the first line number signal may represent that odd gate lines driven.

As described above, the buffer 510 may receive multi-bit (e.g., 24-bit) input pixel data and may generate multi-bit (e.g., 96-bit) current pixel data. Therefore, in the third condition, the data mapping unit 540 may generate the combination pixel data using only the previous pixel data. In this example, combination pixel data to be supplied to the (n+1)-th source driver SD(n+1) may be generated by using only dummy data. Combination pixel data supplied to the source drivers SD(1) to SD(n) excluding the (n+1)-th source driver SD(n+1) will now be described.

In this example embodiment, the data mapping unit 540 may divide multi-bit (e.g., 96-bit) previous pixel data output from the delay device 520 into a plurality of multi-bit (e.g., 8-bit) data groups and rearrange the order of the divided data groups to generate the combination pixel data to be input to the latch 1010 illustrated in FIG. 10. Because the delay device 510 has a plurality of (e.g., twelve) output lines, the combination pixel data may be generated by changing the order of the output lines. Although the dummy data is illustrated as the previous pixel data in FIG. 10 for convenience, the dummy data may not refer to previous pixel data.

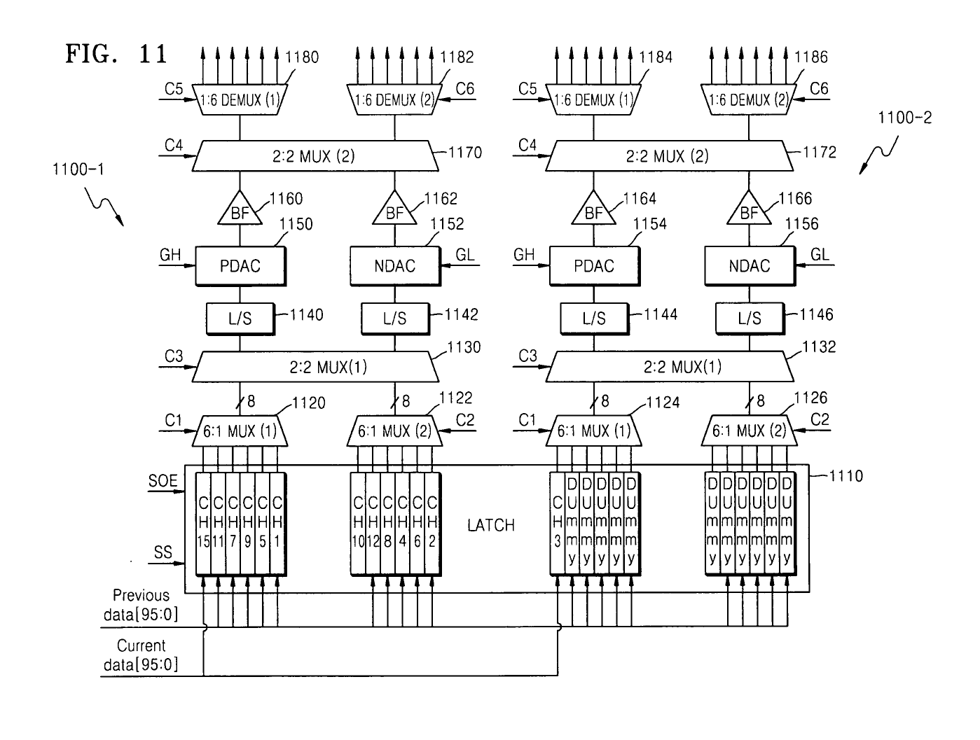

FIG. 11 is a block diagram for explaining a data mapping method according to another example embodiment. In more detail, FIG. 11 is a view illustrating combination pixel data input to a latch 1110 when performing source scanning in the second direction (e.g., from right to left) with respect to the center of a liquid crystal panel and a source driver drives even horizontal lines. Hereinafter, the aforementioned condition is referred to as a fourth condition.

Referring to FIG. 11, source drivers 1100-1 and 1100-2 according to this example embodiment may include the latch 1110, first multiplexer 1120 to 1126, second multiplexers 1130 and 1132, level shifters 1140 to 1146, DACs 1150 to 1156, buffers 1160 to 1166, third multiplexers 1170 and 1172, and demultiplexers 1180 to 1186. The latch 1110 and the demultiplexers 1180 to 1186 will be described in more detail below. Although not shown in the figure, the number of the source drivers 1100-1 and 1100-2 is not 2, but (n+1).

Referring to FIG. 11, the 1:6 demultiplexer 1180 may be connected to a plurality of (e.g., six) source lines included in the liquid crystal panel 700 illustrated in FIG. 7. For example, the output lines of the 1:6 demultiplexer 1180 may be connected to odd source lines (e.g., (12n−1)-th, (12n−3)-th, (12n−5)-th, (12n−7)-th, (12n−9)-th, and (12n−11)-th source lines). Similarly, the 1:6 demultiplexer 1182 may be connected to a plurality of (e.g., six) source lines included in the liquid crystal panel 700 illustrated in FIG. 7. For example, the output lines of the 1:6 demultiplexer 1182 may be connected to even source lines (e.g., (12n)-th, (12n−2)-th, (12n−4)-th, (12n−6)-th, (12n−8)-th, and (12n−10)-th source lines). The demultiplexer 1184 may be connected to a (12n+1)-th source line.

Returning to FIG. 5, the timing controller 500 according to this example embodiment may include the data mapping unit 540 to generate the combination pixel data using the current pixel data and the previous pixel data. The control signal generator 530 may generate a scan direction signal SDS and a line number signal LNS. Therefore, the timing controller 500 according to this example embodiment may generate and supply the combination pixel data corresponding to a source scan direction and a gate line number to the source drivers 1100-1 and 1100-2.

The data mapping unit 540 may receive the current pixel data, the previous pixel data, a second scan direction signal, and a second line number signal and generate the combination pixel data using the current pixel data and the previous pixel data. The combination pixel data may be generated using a portion of the current pixel data and a portion of the previous pixel data. In this example, a portion of the previous pixel data may be excluded and replaced by a portion of the current pixel data. The excluded portion of the previous pixel data may correspond to the portion of the current pixel data used in generating the combination pixel data. For example, the combination pixel data may be generated using 88 bits of the previous pixel data, excluding 8 bits that are third to last, and the third to last 8 bits of the current pixel data. In this example, the data mapping unit 540 may also generate dummy data to be supplied to the (12n+1)-th source line.

In FIG. 11, the (12n+1)-th source driver SD(n+1) may be connected to twelve source lines. This represents that the (12n+1)-th source driver SD(n+1) has the same or substantially the same construction as those of remaining source drivers SD(1) to SD(n). Accordingly, the (12n+1)-th source driver SD(n+1) may be connected to only the (12n+1)-th source line.

As described above, the buffer 510 may receive 24-bit input pixel data and generate 96-bit current pixel data. Therefore, in the fourth condition, the combination pixel data may be generated by using a portion of the current pixel data and a portion of the previous pixel data. Combination pixel data to be supplied to the (n+1)-th source driver SD(n+1) may be generated using the current pixel data and the dummy data. Combination pixel data supplied to the source drivers SD(1) to SD(n) excluding the (n+1)-th source driver SD(n+1) is described.

The data mapping unit 540 may divide 96-bit previous pixel data output from the delay device 520 into 8-bit groups, extract data groups excluding a data group that is third to last, divide the 96-bit current pixel data output from the buffer 510 into 8-bit groups, extract a data group that is third to last, and rearrange the order of the extracted data groups, to generate the combination pixel data to be input to the latch 1110 illustrated in FIG. 11. If each of the buffer 510 and the delay device 520 has twelve output lines, the combination pixel data may be generated by changing the order of the output lines.

Accordingly, in LCDs and data mapping methods according to example embodiments, a more simple data mapping method may be performed using current pixel data and previous pixel data in the timing controller so that various inversion methods may be implemented more effectively, and/or various timing problems that may occur in the source drivers may be suppressed and/or prevented.

While example embodiments have been particularly shown and described with reference to the example embodiments shown in the drawings, it will be understood by those skilled in the art that various changes in form and details may be made therein without departing from the spirit and scope of the present invention as defined by the appended claims.

What is claimed is:

1. A liquid crystal display (LCD) comprising:
a liquid crystal panel including a plurality of subpixels;
a plurality of source drivers, each of the plurality of source drivers being configured to drive a plurality of source lines of the liquid crystal panel;
a plurality of gate drivers, each of the plurality of gate drivers being configured to drive a plurality of gate lines of the liquid crystal panel; and
a timing controller configured to generate combination pixel data based on at least one of current pixel data and previous pixel data, the timing controller being further configured to supply the generated combination pixel data to the plurality of source drivers, the previous pixel data being generated by delaying the current pixel data by a time period.

2. The LCD of claim 1, wherein the timing controller generates the combination pixel data according to a source scan direction and a gate line number.

3. The LCD of claim 2, wherein the timing controller generates the combination pixel data based only on the current pixel data when the source scan direction is a first of a plurality of source scan directions and the gate line number is a first of a plurality of line numbers.

4. The LCD of claim 3, wherein the timing controller generates the combination pixel data based on the current pixel data and the previous pixel data when the source scan direction is a first of a plurality of directions and the gate line number is a second of a plurality of line numbers.

5. The LCD of claim 3, wherein the timing controller generates the combination pixel data based only on the previous pixel data when the source scan direction is a second of a plurality of directions and the gate line number is a first of a plurality of line numbers.

6. The LCD of claim 3, wherein the timing controller generates the combination pixel data based on the current pixel data and the previous pixel data when the source scan direction is a second of a plurality of directions and the gate line number is a second of a plurality of line numbers.

7. The LCD of claim 1, wherein the timing controller generates the combination pixel data based on a structure of the liquid crystal panel.

8. The LCD of claim 1, wherein the timing controller generates the combination pixel data based on a structure of the plurality of source drivers.

9. The LCD of claim 1, wherein the timing controller generates the combination pixel data based on a portion of the current pixel data and a portion of the previous pixel data.

10. The LCD of claim 9, wherein the portion of the previous pixel data corresponds to an excluded portion of the current pixel data.

11. The LCD of claim 10, wherein the excluded portion of the current pixel data includes a last 8 bits in a sequence of the current pixel data and the portion of the previous pixel data includes a last 8 bits in a sequence of the previous pixel data.

12. The LCD of claim 9, wherein a number of bits included in the portion of the current pixel data is larger than a number of bits included in the portion of the previous pixel data.

13. The LCD of claim 9, wherein the portion of the current pixel data corresponds to an excluded portion of the previous pixel data

14. The LCD of claim 13, wherein the portion of the current pixel data includes 8-bit pixel data that is third to last in a sequence of the current pixel data, and the excluded portion of the previous pixel data includes 8-bit pixel data that is third to last in a sequence of the previous pixel data.

15. The LCD of claim 9, wherein a number of bits included in the portion of the previous pixel data is larger than a number of bits included in the portion of the current pixel data.

16. The LCD of claim 1, wherein the timing controller generates (N×M)-bit current pixel data, where M is a natural number, by buffering N-bit input pixel data, where N is a natural number.

17. The LCD of claim 16, wherein M is determined according to a number of source lines connected to each of the plurality of source drivers and a number of bits of pixel data.

18. The LCD of claim 17, wherein the number of the source lines is 12, the pixel data is 8 bit pixel data, N is 24, and M is 4.

19. The LCD of claim 1, wherein the plurality of subpixels are connected to a plurality of first source lines that are adjacent to each other in a first direction along a first horizontal line, and connected to a plurality of second source lines that are adjacent to each other in a second direction along a second horizontal line.

20. The LCD of claim 19, wherein the liquid crystal panel includes,
a plurality of odd source lines connected in common, and
a plurality of even source lines connected in common, wherein each source driver includes,
a first output line connected to the plurality of odd source lines, and
a second output line connected to the plurality of even source lines.

21. A timing controller comprising:
a buffer configured to generate (N×M)-bit current pixel data based on N-bit input pixel data;
a delay device configured to generate (N×M)-bit previous pixel data by delaying the current pixel data by a first time period;
a control signal generator configured to generate a source scan direction signal and a gate line number signal; and
a data mapping unit configured to generate combination pixel data based on at least one of the current pixel data and the previous pixel data, the combination pixel data being generated according to the source scan direction signal and the gate line number signal.

22. The timing controller of claim 21, wherein the data mapping unit is configured to generate the combination pixel data based on both the current pixel data and the previous pixel data.

23. The timing controller of claim 21, wherein the time period corresponds to a time to supply the combination pixel data to each of a plurality of source drivers.

24. The timing controller of claim 21, wherein the control signal generator is configured to,
generate a first source scan direction signal representing that a source scan direction is a first direction with respect to the center of a liquid crystal panel, and
generate a second source scan direction signal representing that the source scan direction is a second direction with respect to the center of the liquid crystal panel, the first direction being different from the second direction.

25. The timing controller of claim 21, wherein the control signal generator is further configured to,
generate a first line number signal representing that a gate line number is an odd line, and
generate a second line number signal representing that the gate line number is an even line.

26. The timing controller of claim 21, wherein the data mapping unit is configured to generate dummy data according to the source scan signal and the gate line number and supplies the dummy data to the source driver.

27. A method of driving a liquid crystal panel comprising:
generating combination pixel data based on at least one of current pixel data and previous pixel data, the previous pixel data being generated by delaying the current pixel data by a time period, the combination pixel data being generated according to a source scan direction and a gate line number; and
driving the liquid crystal panel by supplying the generated combination pixel data to a source driver.

28. The method of claim 27, wherein the generating the combination pixel data includes at least one of,
generating the combination pixel data based only on the current pixel data when the source scan direction is a first of a plurality of source scan directions and the gate line number is a first of a plurality of line numbers,
generating the combination pixel data based on the current pixel data and the previous pixel data when the source scan direction is a first or a second of a plurality of directions and the gate line number is a second of a plurality of line numbers, and
generating the combination pixel data based only on the previous pixel data when the source scan direction is a second of a plurality of directions and the gate line number is a first of a plurality of line numbers.

29. The method of claim 27, wherein the current pixel data is (24×M)-bit current pixel data, and the method further comprises:
generating the (24×M)-bit current pixel data, where M is a natural number, by buffering 24-bit input pixel data.
